(19) United States
(12) Patent Application Publication
(10) Pub. No.: US 2016/0105307 A1
(43) Pub. Date: Apr. 14, 2016

(54) MANAGEMENT SYSTEM AND INFORMATION PROCESSING METHOD

(71) Applicant: CANON KABUSHIKI KAISHA, Tokyo (JP)

(72) Inventor: Yasuhiro Kujirai, Tokyo (JP)

(21) Appl. No.: 14/875,525

(22) Filed: Oct. 5, 2015

(30) Foreign Application Priority Data
Oct. 8, 2014 (JP) 2014-207310

(51) Int. Cl. H04L 12/24

(52) U.S. Cl. CPC H04L 41/0668; H04L 41/20

(57) ABSTRACT

The present invention relates to a management system with a management agent program installed and communicable with a first information processing apparatus registered as a management agent via a network. The management system receives, from the first information processing apparatus, communication information of a network device which failed in communication for monitoring with the first information processing apparatus among network devices as management targets of the first information processing apparatus and performs control to register a second information processing apparatus as a management agent to perform the communication for monitoring with the network device corresponding to the received communication information.

### BACKGROUND OF THE INVENTION

1. Field of the Invention

The present invention relates to a technique for constructing a system managing a network device.

2. Description of the Related Art

Recently, there is a method which realizes a device management service by a server on the Internet as a cloud service. A device management service is to perform device management, failure recovery, management of a printing status, and the like of an image forming apparatus (a copy machine and a printer) as an example of a network device owned by a customer.

In such a device management service, a management agent software installed in a computer in a customer network environment collects a usage status of the image forming apparatus and transmits the status to a management server on the Internet using, for example, a HyperText Transfer Protocol Secure (HTTPS) protocol.

According to increases of demands for introduction and opportunities of trial use before introduction with respect to the management system such as the device management service, a cloud service provider needs to handle many requests for introduction and for trial use of the management system in one day in some cases. Thus, reduction of an operational cost for introducing software to the network of the customer is highly demanded. Therefore, the management system may include a configuration which allows a customer to download an installer of a management agent program from the management server. In this case, the customer downloads the installer of the management agent program and installs the management agent program. A management agent is started in the network of the customer and then searches an image forming apparatus in the network by a Simple Network Management Protocol (SNMP) based on a management information base (MIB). The management system regards the searched image forming apparatus as a management target in the management system. Accordingly, a registration operation of a device to be managed is efficiently performed.

The customer network environment to be a service target generally includes a plurality of network segments, and each segment is divided by a router and the like.

Japanese Patent Application Laid-Open No. 2003-186761 describes a technique in which a data collecting terminal device disposed in a network including a plurality of network segments collects data from a terminal as a diagnostic target and transmits the data to a diagnostic system via a public network, and the diagnostic system executes a diagnosis.

In a conventional management system, a management agent is connected to a network device as a management target to obtain information about an operation status and a printing function usage status. However, in communication across a plurality of network segments, communication using a specific port for collecting information from the network device may be blocked by a router and the like in the network.

According to the above-described Japanese Patent Application Laid-Open No. 2003-186761, it is assumed that the data collecting terminal device is disposed on a network bus which can perform data collection with respect to all segments in the network, and it is not assumed a case in which the data collecting terminal device is disposed on a network bus which cannot collect data.

Along with construction of the management system, the management agent needs to be appropriately disposed in consideration of a network segment. However, an operation for checking a network environment and specifying the number and arrangement of necessary management agents in advance by hand with respect to an environment of an individual customer who wants to construct the management system is a factor to increase an operational cost in a business operation.

In the present situation, when a management system is constructed, there is an issue that introduction of a management agent cannot be efficiently realized in a low cost to a network environment in which a network device as a management target owned by a customer exists.

### SUMMARY OF THE INVENTION

The present invention is directed to efficient introduction of a management agent to a network environment in which a management target network device exists.

According to the present invention, a management system with a management agent program installed and communicable with a first information processing apparatus registered as a management agent via a network includes a first reception unit configured to receive, from the first information processing apparatus, communication information of a network device which failed in communication for monitoring with the first information processing apparatus among network devices as management targets of the first information processing apparatus, a control unit configured to perform control to register a second information processing apparatus as a management agent to perform the communication for monitoring with the network device corresponding to the received communication information, a transmission unit configured to transmit to the second information processing apparatus an installer which includes a setting of prohibiting installation to a device not existing in a network segment to which the network device corresponding to the received communication information belongs, and a change unit configured to change a search range so as to delete the network segment to which the network device corresponding to the received communication information belongs from the search range set with respect to the first information processing apparatus, wherein, in a case where the transmitted installer is executed in the second information processing apparatus existing in the network segment to which the network device corresponding to the received communication information belongs, a management agent program for managing the network device corresponding to the received communication information is installed in the second information processing apparatus.

Further features of the present invention will become apparent from the following description of exemplary embodiments with reference to the attached drawings.

### BRIEF DESCRIPTION OF THE DRAWINGS

FIGS. 1A and 1B illustrate examples of a system configuration and the like of a network system.

FIG. 2 illustrates an example of a hardware configuration of a computer and the like.

FIG. 3 illustrates an example of a hardware configuration of an image forming apparatus.

FIG. 4 illustrates an example of a software configuration of a management agent.

FIG. 5 illustrates an example of a software configuration of a management server.

FIG. 6 is an example of a table recorded by an agent management unit.

FIG. 7 is an example of a table recorded by a device information management unit.

FIG. 8 illustrates an example of a software configuration and the like of the image forming apparatus.

FIG. 9 is a flowchart illustrating an example of introduction start processing of the network system.

FIGS. 10A and 10B illustrate examples of a management agent registration screen.

FIG. 11 illustrates an example of a screen displaying a management status of the image forming apparatus.

FIG. 12 is a flowchart illustrating an example of device search processing.

FIGS. 13A and 13B are flowcharts illustrating an example of processing in an entire network system.

FIGS. 14A, 14B, and 14C illustrate examples of screens displaying a management agent additional registration procedure.

FIG. 15 is a flowchart illustrating an example of management agent additional registration processing.

FIG. 16 illustrates an example of a management agent additional registration processing mode setting screen.

FIGS. 17A and 17B illustrate examples of screens displaying a device association procedure.

FIGS. 18A, 18B, and 18C are examples of tables indicating a status change in the agent management unit.

FIG. 19 is a flowchart illustrating an example of the management agent additional registration processing.

FIG. 20 is an example of a table indicating status examples of the device information management unit.

FIGS. 21A and 21B are flowcharts illustrating an example of processing in the entire network system.

FIG. 22 illustrates an example of a communication error cancellation method selection screen.

FIG. 23 is a flowchart illustrating an example of communication error cancellation method selection processing.

FIG. 24 is a flowchart illustrating an example of search setting automatic updating processing.

### DESCRIPTION OF THE EMBODIMENTS

Exemplary embodiments of the present invention will be described below with reference to the drawings.

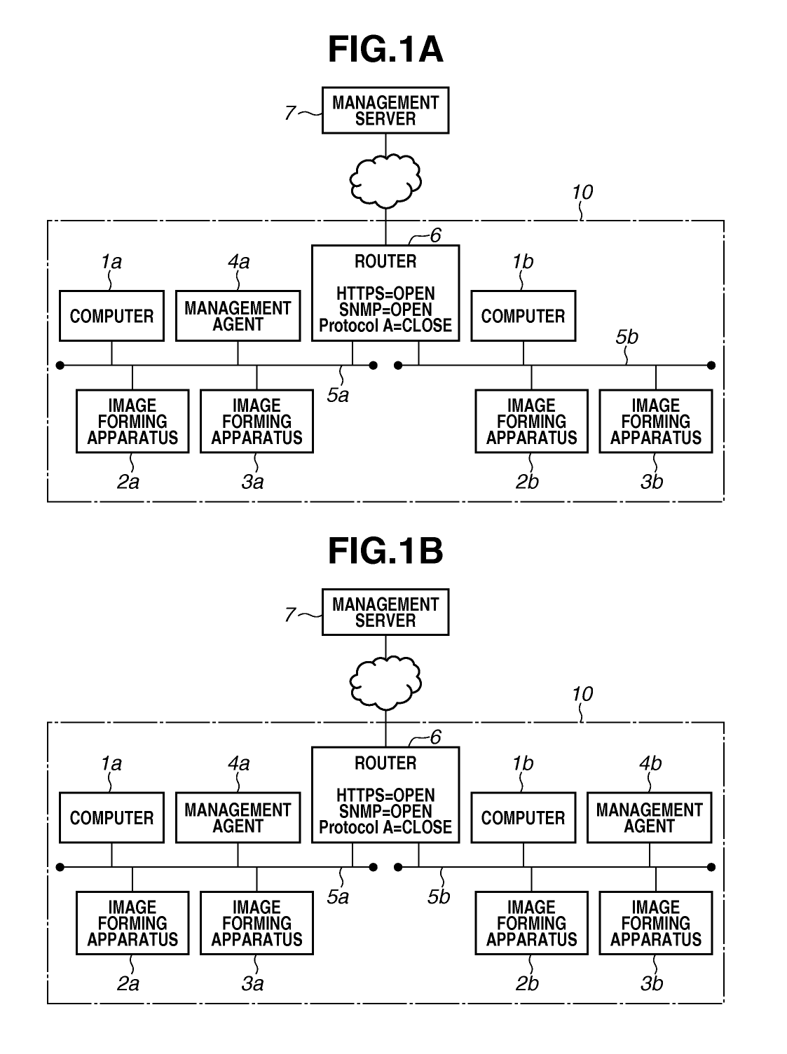

FIGS. 1A and 1B illustrate examples of a system configuration and the like of a network system. FIG. 1A illustrates a status of the network system before a management agent is added. FIG. 1B illustrates a status of the network system after the management agent is added. According to a first exemplary embodiment, the network system includes computers 1a and 1b, image forming apparatuses 2a, 2b, 3a, and 3b, management agents 4a and 4b, network segments 5a and 5b, a router 6, a management server 7, and a customer network 10. The customer network 10 is an example of an area set as an introducing target of a network system. The management agent 4a is an example of an information processing apparatus which exists in the area, is installed with a management agent program, and registered as a management agent by the management server 7.

The computers 1a and 1b are each an example of a computer connected to the customer network 10. The image forming apparatuses 2a, 2b, 3a, and 3b are image forming apparatuses, such as multifunction peripherals connected to the customer network 10. The management agents 4a and 4b are information processing apparatuses, such as computers which are installed with the management agent program and function as the management agents. The network segments 5a and 5b are network segments in the customer network 10.

The router 6 is a router which divides the customer network 10 to the network segments 5a and 5b and connects the customer network 10 to the external Internet. The management server 7 is a server apparatus which manages information received from the management agents 4a and 4b and is disposed outside of the customer network 10. The customer network 10 is a network to which the network system is introduced. According to the present exemplary embodiment, the customer network 10 includes the network segments 5a and 5b, and each network segment is separated by the router 6. To the network segment 5a, the image forming apparatuses 2a and 3a are connected, and to the network segment 5b, the image forming apparatuses 2b and 3b are connected.

The router 6 also has a firewall function. The management agents 4a and 4b communicate with the management server 7 via the Internet using a protocol, such as an HTTPS protocol. The management agents 4a and 4b connect to the image forming apparatus connected to the customer network 10 using a predetermined protocol (a Protocol A according to the present exemplary embodiment) and obtain information about an operation status, a printing function usage status, and the like from the image forming apparatus.

In FIG. 1A, the management agent 4a is connected to the network segment 5a and searches for the image forming apparatuses (the image forming apparatuses 2a, 3a, 2b, and 3b, and so on) connected to the customer network 10 using an SNMP based on the MIB. However, the router 6 blocks communication of the Protocol A, and the management agent 4a cannot collect information about the usage status and the like from the image forming apparatuses 2b and 3b.

In other words, in FIG. 1A, the management agent 4a succeeds in a search for the image forming apparatus by the SNMP based on the MIB between the network segments 5a and 5b and regards the image forming apparatuses 2b and 3b as the management targets. Further, the management agent 4a is blocked by the router 6 the communication by a protocol used for information obtainment. Thus, a person who introduces the network system cannot properly complete introduction of the network system. In addition, if the person who introduces the network system requests a customer network administrator to open a port necessary for communication, the customer network administrator does not accept the request in some cases in terms of security.

In the case of FIG. 1A, the network system may operate the management agent 4b in the network segment 5b as illustrated in FIG. 1B and cause the management agent 4b to collect information about the usage statuses and the like of the image forming apparatuses 2b and 3b. The management agent 4b obtains information about the usage statuses and the like from the image forming apparatuses 2b and 3b and transmits the information to the management server 7.

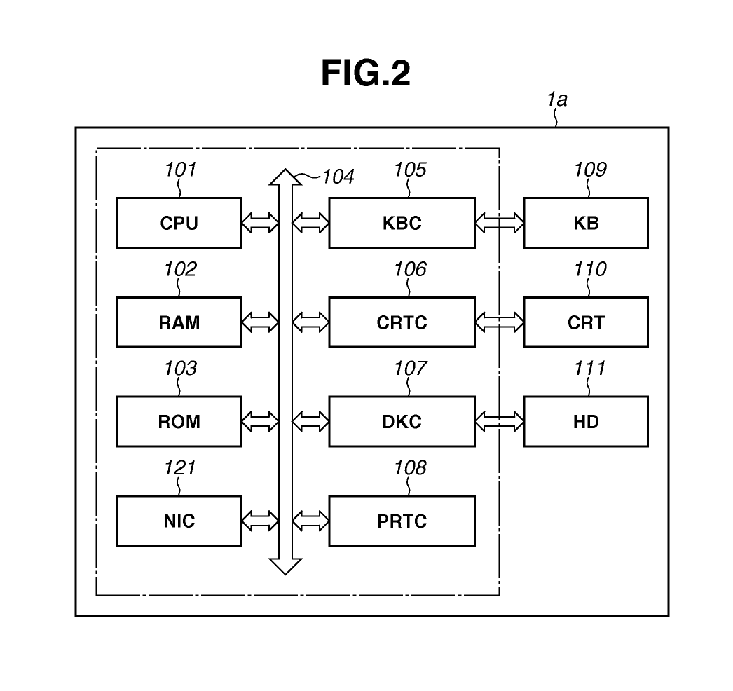

FIG. 2 illustrates an example of a hardware configuration of the computer 1a and the like. The computer 1b, the management agents 4a and 4b, and the management server 7 include hardware configurations similar to that in FIG. 2.

In FIG. 2, the computer 1a includes a central processing unit (CPU) 101, a random access memory (RAM) 102, a read-only memory (ROM) 103, a system bus 104, a keyboard controller (KBC) 105, a cathode ray tube controller (CRTC) 106, and a disk controller (DKC) 107. The computer 1a further includes a printer controller (PRTC) 108, a keyboard (KB) 109, a cathode ray tube display (CRT) 110, a hard disk (HD) 111, a network interface (NIC) 121, and the like.

The CPU 101 executes document processing including graphics, images, characters, tables (including spreadsheets) and the like based on a document processing program and the like stored in a program ROM in the ROM 103 or the HD 111.

In the computer 1a, the CPU 101 executes processing based on a program stored in the ROM 103 or the HD 111, so that functions of the computer 1a are realized. The same applies to the computer 1b.

A CPU of the management agent 4a executes processing based on a program stored in a ROM or an HD of the management agent 4a, so that functions and processing in a flowchart, which is described below, of the management agent 4a are realized.

A CPU of the management agent 4b executes processing based on a program stored in a ROM or an HD of the management agent 4b, so that functions and processing in a flowchart, which is described below, of the management agent 4b are realized.

A CPU of the management server 7 executes processing based on a program stored in a ROM or an HD of the management server 7, so that functions and processing in a flowchart, which is described below, of the management server 7 are realized.

The RAM 102 is a main storage device which functions as a main memory, a work area, and the like of the CPU 101. The ROM 103 is a storage device which stores a program, data, and the like. Each hardware configuration of the computer 1a is connected with each other via the system bus 104.

The KBC 105 controls a key input from the KB 109, a pointing device, and the like. The CRTC 106 controls display of the CRT 110. The DKC 107 controls access to the HD 111 and an external memory, such as a flexible disk. The PRTC 108 is network-connected to an external image forming apparatus via the NIC 121 and controls communication with the image forming apparatus.

The KB 109 is a keyboard of the computer 1a. The CRT 110 is a CRT display of the computer 1a. The HD 111 is a hard disk of the computer 1a.

A program area of the ROM 103 or the HD 111 stores programs such as an operating system (hereinbelow referred to as an OS) of the computer 1a. Further, the ROM 103 or the HD 111 stores font data and other various data pieces used for performing the document processing.

The HD 111 stores a boot program, various applications, font data, user files, editing files, a printer control command generation program (hereinbelow referred to as a printer driver), and the like.

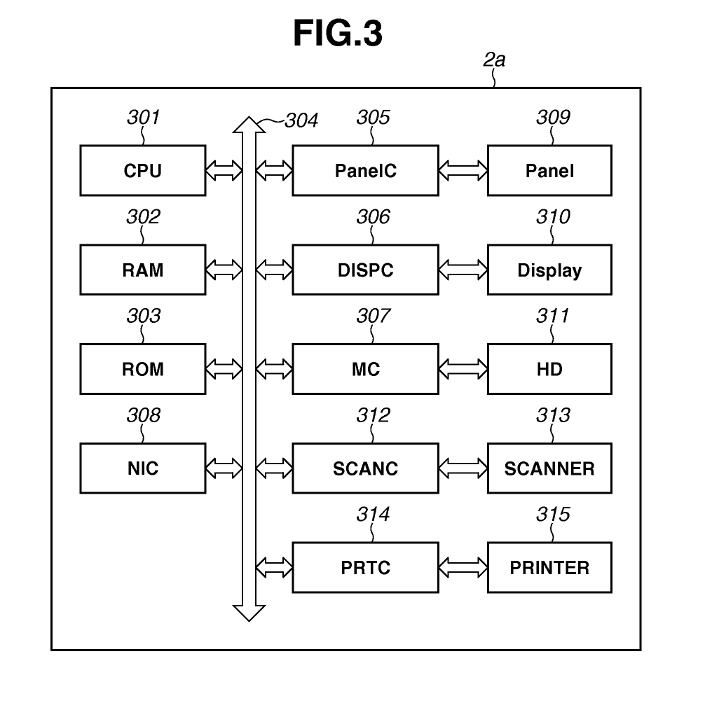

FIG. 3 illustrates an example of a hardware configuration of the image forming apparatus 2a. The image forming apparatuses 2b, 3a, and 3b include hardware configurations similar to that in FIG. 3.

The image forming apparatuses 2a, 3a, 2b, and 3b are devices which actually print printing data received via the network on a sheet using a known print technique, such as an electrophotographic technique and an inkjet technique. The image forming apparatuses 2a, 3a, 2b, and 3b are examples of the network devices.

The image forming apparatus 2a includes a CPU 301, a RAM 302, a ROM 303, a system bus 304, a panel controller (PanelC) 305, a display controller (DISPC) 306, and a memory controller (MC) 307. The image forming apparatus 2a also includes an NIC 308, an operation panel (Panel) 309, a display module (Display) 310, and an HD 311. The image forming apparatus 2a further includes a scanner controller (SCANC) 312, a scanner 313, a PRTC 314, a printer 315, and the like.

The image forming apparatus 2a has functions of reading a paper document via the scanner 313, copying, converting the read data to image data, transmitting the image data by an electronic mail (E-mail), and the like. The image forming apparatus 2a and the management agent 4a can communicate with each other via the network segment 5a.

The CPU 301 outputs an image signal to the printer 315 connected to the system bus 304 via the PRTC 314 based on a control program and the like stored in the ROM 303 or the HD 311.

The CPU 301 executes processing based on a program stored in the ROM 303 or the HD 311, so that functions and processing in a flowchart, which is described below, of the image forming apparatus 2a are realized. The same applies to the image forming apparatuses 3a, 2b, and 3b.

A CPU of each of the image forming apparatuses 3a, 2b, and 3b executes processing based on a program stored in a ROM or an HD of each of the image forming apparatuses 3a, 2b, and 3b, so that functions and processing of each of the image forming apparatuses 3a, 2b, and 3b are realized.

The RAM 302 is a main storage device which functions as a main memory, a work area, and the like of the CPU 301 and can expand a memory capacity by an option RAM connected to an expansion port. The RAM 302 is used as an output information expansion area, an environment data storage area, a non-volatile RAM, and the like. The ROM 303 is a storage device which stores a program, data, and the like. Each hardware configuration of the image forming apparatus 2a is connected with each other via the system bus 304.

The PanelC 305 controls a command input from the Panel 309. The DISPC 306 controls display of the Display 310. The MC 307 performs access control of the HD 311 and an external memory, such as an integrated circuit (IC) card. The HD 311 and the external memory, such as the IC card are connected as an option to the image forming apparatus 2a and store font data, an emulation program, form data, and the like. The CPU 301 notifies the management agent 4a of information and the like in the image forming apparatus 2a via the NIC 308.

The Panel 309 is a user interface, such as a touch panel. The Display 310 is a display module including, for example, a liquid crystal display. The HD 311 is a hard disk which stores data, a program, and the like.

The SCANC 312 is a scanner control unit which controls the scanner 313, such as an optical scanner disposed in the image forming apparatus 2a to read a paper document. The PRTC 314 controls the printer 315. The image forming apparatus 2a may include an NVRAM to store printer mode setting information and the like input thereto via the Panel 309.

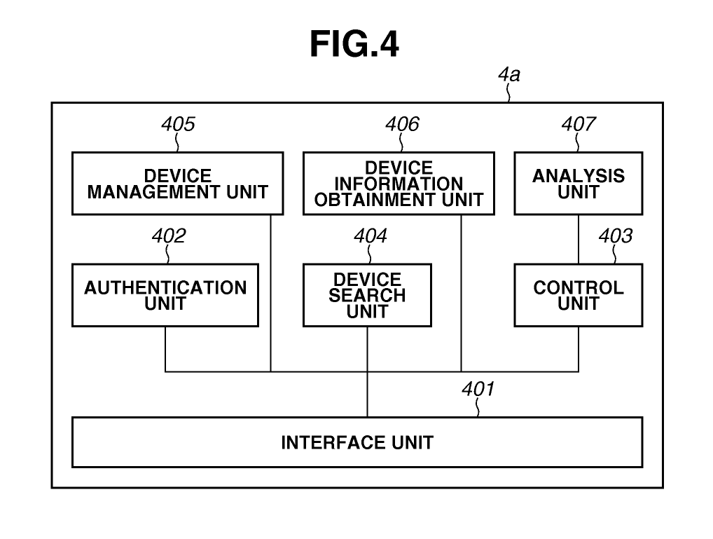

FIG. 4 illustrates an example of a software configuration of the management agent 4a. The management agent 4b includes a software configuration similar to that in FIG. 4. Further, an information processing apparatus newly added as a management agent by the management server 7 includes a software configuration similar to that in FIG. 4.

The management agent 4a includes an interface unit 401, an authentication unit 402, a control unit 403, a device search unit 404, a device management unit 405, a device information obtainment unit 406, an analysis unit 407, and the like as the software configuration.

The interface unit 401 communicates with the computer 1a, the image forming apparatuses 2a and 3a, the router 6, the management server 7, and the like via the NIC 121 and the network segment 5a.

The authentication unit 402 performs authentication processing with respect to communication from outside via the interface unit 401.

The control unit 403 controls device search processing and device information obtainment processing regularly executed by the management agent 4a. In addition, when the management agent 4a functions as a HyperText Transfer Protocol (HTTP) server or an HTTPS server, the control unit 403 receives a request via a web browser via the interface unit 401.

The device search unit 404 stores a device search setting obtained from the management server 7 in the ROM 103, the HD 111, and the like, and searches for the image forming apparatus connected to the network segment 5a based on the device search setting. The device search unit 404 notifies the device management unit 405 of information indicating a search result.

The device management unit 405 transmits information of the image forming apparatus searched by the device search unit 404 to the management server 7. The device management unit 405 obtains information about a management status of the image forming apparatus in the management server 7 from the management server 7.

The device information obtainment unit 406 obtains information pieces, such as a job history, counter information, error information, and a toner level from the image forming apparatus registered as the management target among the image forming apparatuses registered in the device management unit 405.

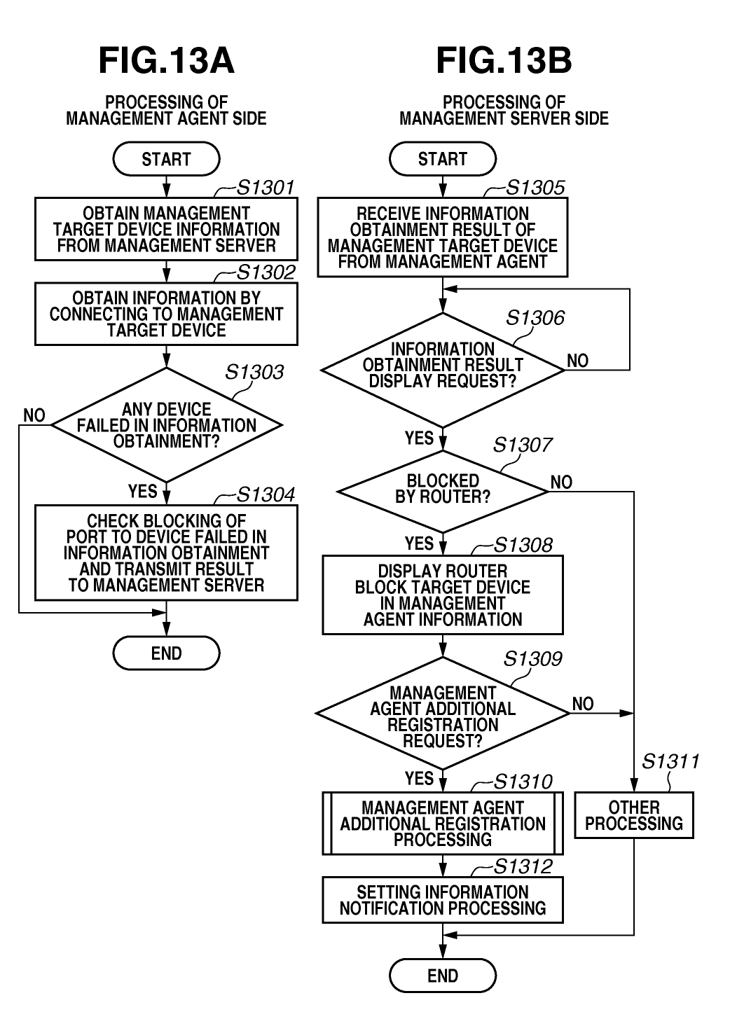

The analysis unit 407 performs various types of processing, such as determination of success and failure of device information obtainment in the network environment which is described below with reference to FIG. 13.

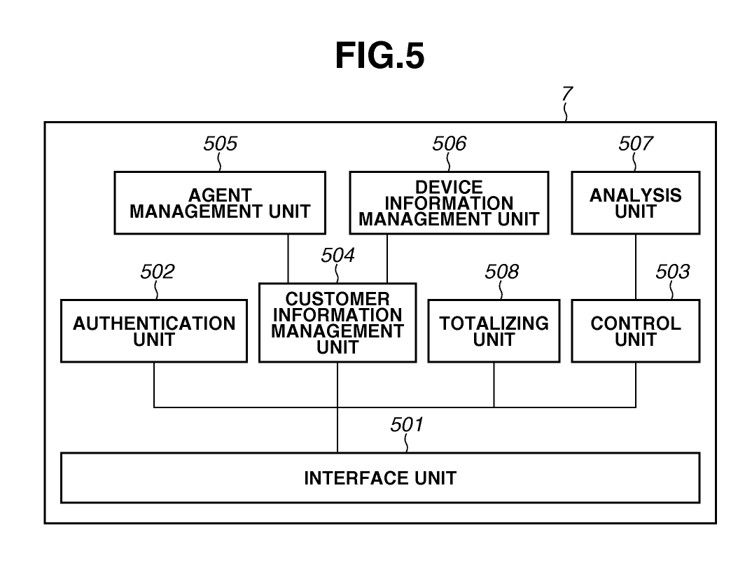

FIG. 5 illustrates an example of a software configuration of the management server 7.

The management server 7 includes an interface unit 501, an authentication unit 502, a control unit 503, a customer information management unit 504, an agent management unit 505, a device information management unit 506, an analysis unit 507, a totalizing unit 508, and the like as the software configuration.

The interface unit 501 communicates with the computers 1a and 1b, the image forming apparatuses 2a, 3a, 2b, and 3b, the router 6, the management agents 4a and 4b, and the like via the NIC 121 and the network segments 5a and 5b.

The authentication unit 502 performs authentication processing with respect to communication from outside via the interface unit 501.

The control unit 503 controls display of a user interface, transmission of a mail, management agent additional registration processing according to the present exemplary embodiment, and the like which are requested from the outside via the interface unit 501.

The customer information management unit 504 stores and manages customer information including a customer name, a notification destination mail address of the customer, an address, a setting of a closing date of totalization, and the like in a storage unit (a storage unit corresponding to ROM 103, the HD 111, and the like in FIG. 2) of the management server 7. The customer information management unit 504 further stores and manages management agent information and image forming apparatus information for each customer in the storage unit.

The agent management unit 505 stores and manages information about one or a plurality of the management agents for each customer in a storage unit, such as the ROM and the HD of the management server 7.

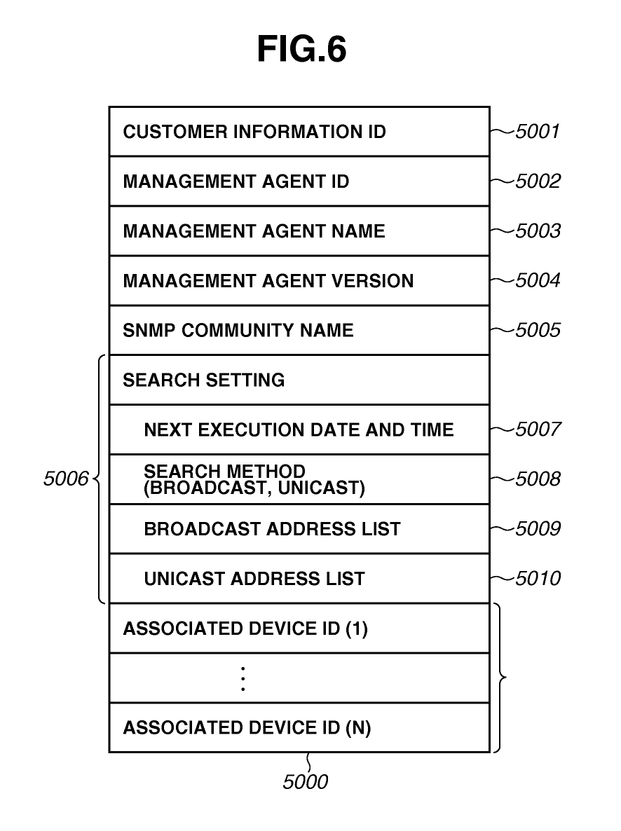

FIG. 6 is an example of a table recorded by the agent management unit 505. A table 5000 in FIG. 6 is an example of a table recorded by the agent management unit 505. The table 5000 includes a customer information identification (ID) 5001 corresponding to a management client, a management agent ID 5002, a management agent name 5003, a management agent version 5004, an SNMP community name 5005, a search setting 5006 for device search, and the like.

The search setting 5006 includes a next execution date and time 5007, a search method (broadcast and unicast) 5008, a broadcast address list 5009, and a unicast address list 5010. Data pieces in the table 5000 in FIG. 6 are stored in the storage unit, such as the ROM and the HD of the management server 7.

The customer information ID 5001 is an identifier for specifying a customer in the network system. The management agent ID 5002 is an identifier for specifying a management agent registered with respect to the customer corresponding to the customer information ID 5001. The management agent name 5003 is a name added to the management agent which can be confirmed on a user interface displayed by the control unit 503 of the management server 7. The management agent version 5004 indicates version information of a management agent software program. The SNMP community name 5005 indicates an SNMP community name that the management agent corresponding to the management agent ID 5002 uses in the device search or the like.

The management server 7 transmits information of the search setting 5006 to the device search unit 404 in response to, for example, a request from the management agent 4a. Then, the management agent 4a executes the device search based on the information. The next execution date and time 5007 stores an execution date and time of next device search. The search method (broadcast and unicast) 5008 stores information specifying a search method, such as broadcast or unicast. The broadcast address list 5009 is an address list used when the search method (broadcast and unicast) 5008 includes information specifying the broadcast search. The unicast address list 5010 is an address list used when the search method (broadcast and unicast) 5008 includes information specifying the unicast search.

The device information management unit 506 manages information about the image forming apparatus for each customer managed by the customer information management unit 504.

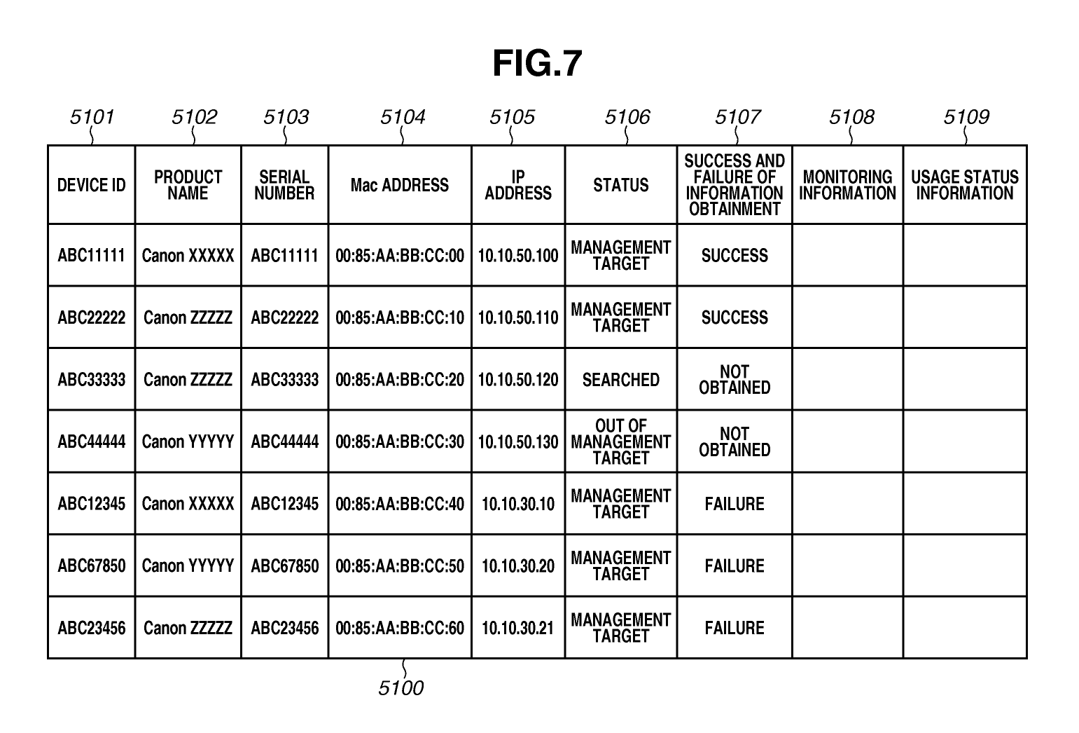

FIG. 7 is an example of a table recorded by the device information management unit 506. A table 5100 in FIG. 7 is an example of a table recorded by the device information management unit 506. The table 5100 includes a device ID 5101, a product name 5102, a serial number 5103, a Mac address 5104, an internet protocol (IP) address 5105, a status 5106 indicating the management status, information obtainment success and failure information 5107, monitoring information 5108, and usage status information 5109. Data pieces in the table 5100 in FIG. 7 are stored in the storage unit, such as the ROM and the HD of the management server 7.

The device ID 5101 is an identifier for specifying the image forming apparatus. The product name 5102 is a product name of the image forming apparatus corresponding to the device ID 5101. The serial number 5103 is a device number uniquely assigned to each image forming apparatus. The Mac address 5104 is an identifier uniquely assigned to a network interface (the NIC 308 and the like) of the image forming apparatus corresponding to the device ID 5101. According to the present exemplary embodiment, the device ID is the serial number 5103. The IP address 5105 is an IP address of the image forming apparatus corresponding to the device ID 5101.

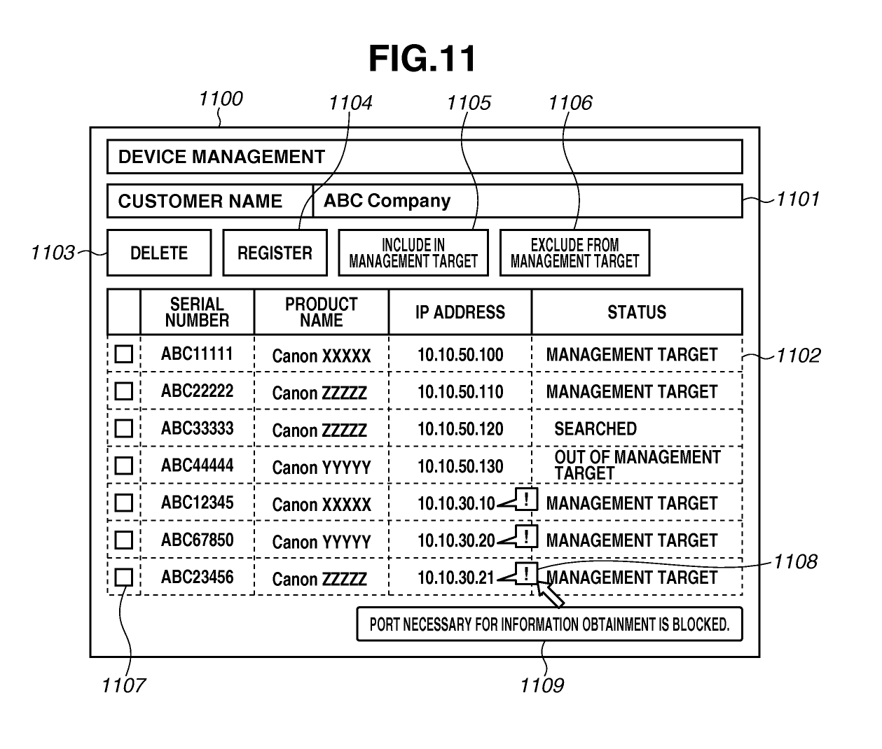

The status 5106 indicates a management status of the image forming apparatus corresponding to the device ID 5101 in the network system. The status 5106 includes values, such as “management target”, “out of management target”, and “searched”. Each status is described below with reference to FIG. 11 and the like. The monitoring information 5108 stores information pieces, such as the error information and the toner level transmitted from a management client. The usage status information 5109 stores information pieces, such as the job history and the counter information transmitted from the management client. Then, the control unit 503 displays the above-described information pieces on a user interface, such as a display of the management server 7 based on an operation performed on the user interface of the management server 7 by a user (a service provider).

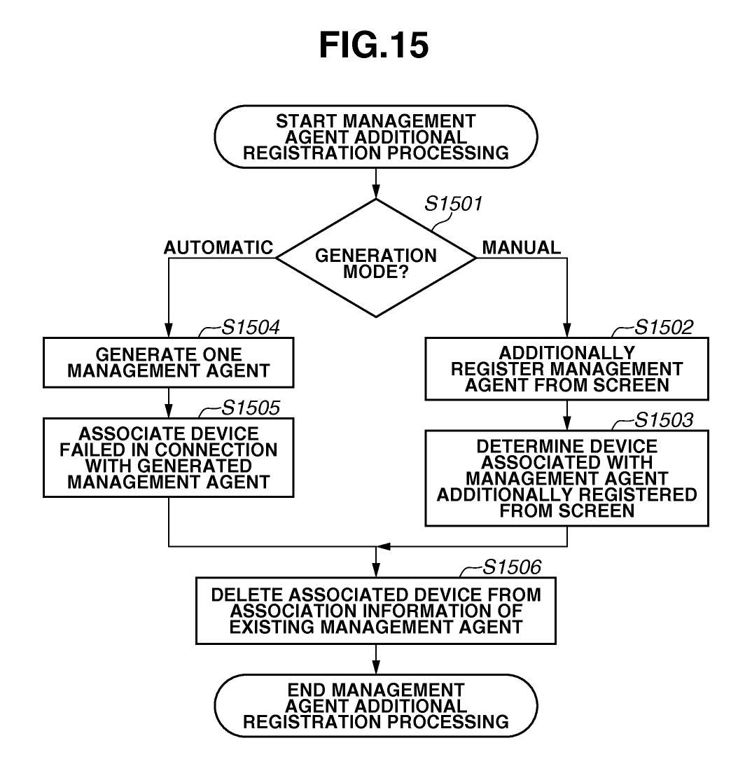

The analysis unit 507 analyzes, for example, the image forming apparatus information obtained by the device information obtainment unit 406 and a determination result of success and failure of device information obtainment by the analysis unit 407 of the management agent 4a. The analysis unit 507 further determines the image forming apparatus to be associated with the management agent additionally registered by management agent additional registration processing described below with reference to FIG. 15.

The totalizing unit 508 performs totalization processing with respect to the image forming apparatus information of each customer obtained by the management agent, report output, and display on the user interface of the management server 7.

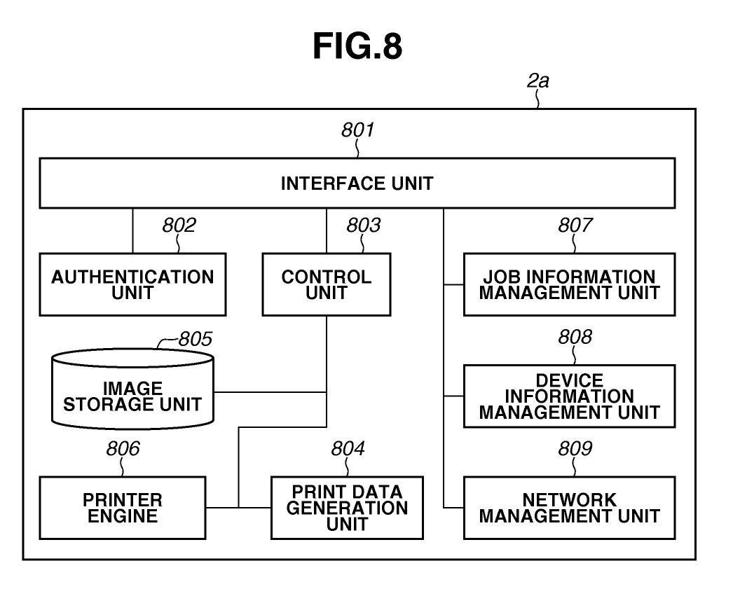

FIG. 8 illustrates an example of a software configuration and the like of the image forming apparatus 2a. The image forming apparatuses 2b, 3a, and 3b include software configurations similar to that in FIG. 8.

An interface unit 801 connects to the network segment 5a to receive a print job from the computer 1a and the like and to transmit information pieces, such as the job history, the counter information, the error information, and the toner level to the management agent 4a. The interface unit 801 further receives a device information obtainment request from the management agent 4a and transmits device information, such as the product name, the device serial number, and the Mac address.

An authentication unit 802 performs authentication processing with respect to communication from outside via the interface unit 801.

A control unit 803 controls various types of job processing, such as scanning, copying, and printing executed in the image forming apparatus 2a. The control unit 803 also controls the Panel 309 via the PanelC 305 and receives a copy instruction, a scanning and transmission instruction, and the like based on an operation performed on the Panel 309. In addition, when the image forming apparatus 2a functions as an HTTP server or an HTTPS server, the control unit 803 receives a request via a web browser operating on the computer 1a and the like via the interface unit 801.

A print data generation unit 804 generates print data corresponding to a print job received by the control unit 803.

An image storage unit 805 temporarily stores print job data generated by the control unit 803 in the RAM 302, the HD 311, and the like in FIG. 3. Then, the control unit 803 transfers the stored print job data to a printer engine 806 to obtain an output product. The printer engine 806 controls processing for printing the print job data on a sheet.

A job information management unit 807 analyzes a job executed in the image forming apparatus 2a to obtain output attribute information, such as the counter information, a user name, the number of printing copies, color printing, and a sheet type and manages the information as job information. In addition, the job information management unit 807 transmits the job information, such as the job history and the counter information to the management agent 4a via the interface unit 801 in response to a request from the management agent 4a.

A device information management unit 808 manages information about the image forming apparatus 2a and setting information.

A network management unit 809 manages information about a network setting of the image forming apparatus 2a.

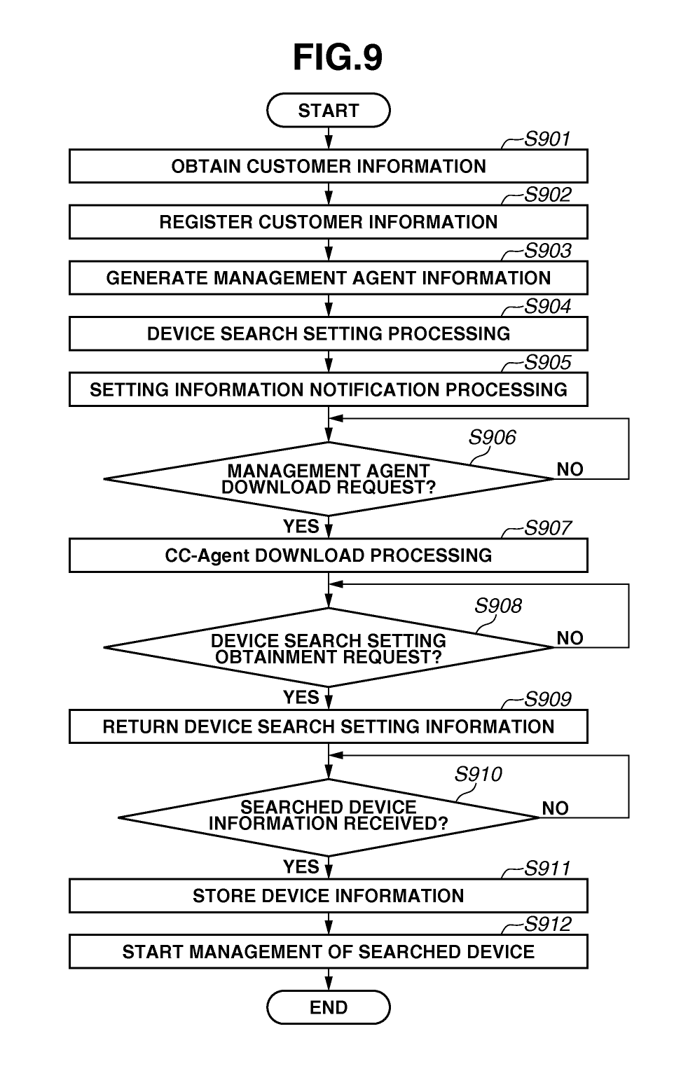

FIG. 9 is a flowchart illustrating an example of introduction start processing of the network system. FIG. 9 illustrates the introduction start processing of the network system in the management server 7.

In step S901, the control unit 503 obtains the customer information based on an operation performed on the user interface of the management server 7 by a user (a service provider).

In step S902, the customer information management unit 504 stores the customer information obtained in step S901 in the storage unit, such as the ROM and the HD of the management server 7.

In step S903, the control unit 503 performs information generation, such as generation of registration information and an installer of the management agent introduced to the customer based on an operation performed on the user interface of the management server 7 by the user (the service provider). The agent management unit 505 stores the generated information in the storage unit, such as the ROM and the HD of the management server 7.

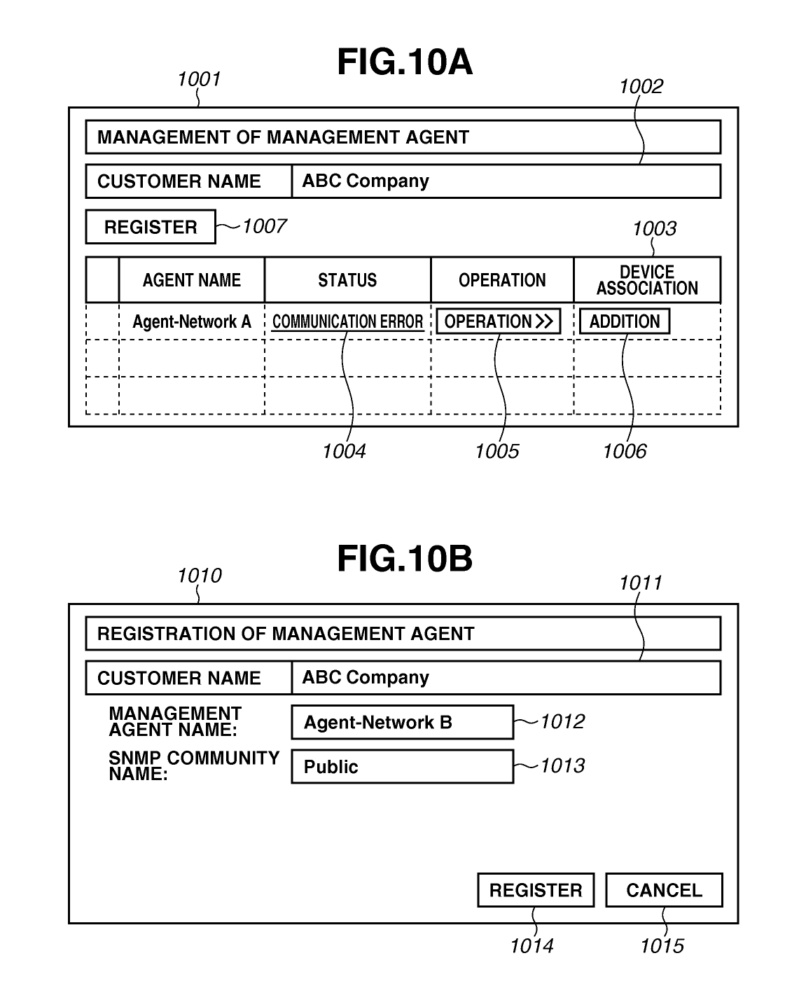

FIGS. 10A and 10B illustrate examples of a management agent registration screen. FIG. 10A illustrates an example of a user interface indicating a management status of the management agent provided by the management server 7. A dialog 1001 in FIG. 10A includes a customer name 1002, a list box 1003 displaying the management agent introduced to the customer corresponding to the customer name 1002, a “register” button 1007, and the like. The list box 1003 includes a status 1004 indicating a status of the management agent, an “operation” button 1005, an “addition” button 1006 for setting a device to be associated with the management agent, and the like. When pressing down of the “register” button 1007 is detected, the management server 7 displays a dialog 1010 illustrated in FIG. 10B and performs a setting of the management agent to be registered via the dialog 1010. The dialog 1010 includes a customer name 1011, a management agent name input area 1012, an SNMP community name input area 1013, and the like. Contents of the management agent name input area 1012 and the SNMP community name input area 1013 are input by a user operation. The management server 7 completes registration processing when detecting pressing down of a “register” button 1014 and discards the processing when detecting pressing down of a “cancel” button 1015.

In step S904, the control unit 503 obtains setting information about the device search executed by the management agent in the customer network environment based on an operation performed on the user interface by the user (the service provider). The agent management unit 505 stores the setting information in the storage unit, such as the ROM and the HD of the management server 7.

In step S905, the control unit 503 performs following processing based on an operation performed on the user interface by the user (the service provider). The management server 7 transmits a mail to an address indicated by the mail address information of the customer stored in the customer information management unit 504. The mail includes address information about a requesting destination of an installer program of the management agent to be introduced to the customer network environment.

In step S906, the control unit 503 determines whether a management agent download request is received from the outside via the interface unit 501. If it is determined that the management agent download request is received from the outside (YES in step S906), the control unit 503 advances the processing to step S907, whereas if it is determined that the management agent download request is not received from the outside (NO in step S906), the control unit 503 repeats the processing in step S906.

In step S907, the control unit 503 transmits the management agent installer generated in step S903 to a request source which makes the download request in step S906.

In step S908, the control unit 503 determines whether a device search setting obtainment request is received from the management agent to which the management agent program is installed by the management agent installer transmitted in step S907. If it is determined that the device search setting obtainment request is received (YES in step S908), the control unit 503 advances the processing to step S909, whereas if it is determined that the device search setting obtainment request is not received (NO in step S908), the control unit 503 repeats the processing in step S908.

According to the present exemplary embodiment, following descriptions are made by regarding the management agent to which the management agent program is installed by the management agent installer transmitted in step S907 as the management agent 4a.

In step S909, the control unit 503 transmits the device search setting information stored in the agent management unit 505 to the management agent 4a as a response to the device search setting obtainment request received in step S908.

In step S910, the control unit 503 determines whether a device search execution result is received from the management agent 4a. If it is determined that the device search execution result is received from the management agent 4a (YES in step S910), the control unit 503 advances the processing to step S911, whereas if it is determined that the device search execution result is not received from the management agent 4a (NO in step S910), the control unit 503 repeats the processing in step S910.

In step S911, the device information management unit 506 stores the device search execution result received in step S910 in the storage unit, such as the ROM and the HD of the management server 7. The analysis unit 507 analyzes the device search execution result and sets “searched” to a value of the status 5106 of the image forming apparatus searched by the management agent 4a.

In step S912, the control unit 503 displays the image forming apparatus information stored by the device information management unit 506 on the user interface of the management server 7 based on an operation performed on the user interface of the management server 7 by the user (the service provider).

FIG. 11 illustrates an example of a screen displaying a management status of the image forming apparatus. FIG. 11 illustrates an example of a screen displaying the management status of the image forming apparatus provided by the management server 7. A dialog 1100 in FIG. 11 includes a customer name 1101 and a list box 1102 displaying the image forming apparatus introduced to the customer corresponding to the customer name 1101. The dialog 1100 further includes a “delete” button 1103, a “register” button 1104, an “include in management target” button 1105, an “exclude from management target” button 1106, a selection check box 1107, and the like.

The management server 7 performs following processing to start a device management service of the device searched by the management agent 4a. In other words, the management server 7 selects the selection check box 1107 corresponding to the image forming apparatus of which status is “searched” in the list box 1102 based on an operation performed on the dialog 1100 by the user (the service provider). When pressing down of the “include in management target” button 1105 is detected, the management server 7 includes the image forming apparatus selected in the selection check box 1107 in the management target in the network system. When pressing down of the “exclude from management target” button 1106 is detected, the management server 7 regards that the image forming apparatus selected in the selection check box 1107 is out of the management target in the network system. Regarding the image forming apparatus out of the management target, the management agent 4a does not perform error monitoring and collection of information necessary for the usage status.

When pressing down of the “delete” button 1103 is detected, the management server 7 deletes information about the image forming apparatus selected in the selection check box 1107 from information managed by the device information management unit 506. Further, when pressing down of the “register” button 1104 is detected, the management server 7 performs following processing. More specifically, the management server 7 performs processing for adding information about the image forming apparatus to the information managed by the device information management unit 506 using an import function which uses an input from the user interface of the management server 7, a comma separated value (CSV) file, and the like, and including the image forming apparatus in the management target.

The management server 7 displays a warning display 1108 on a portion of the IP address regarding the image forming apparatus that the management agent 4a fails in information obtainment therefrom among the image forming apparatuses displayed in the list box 1102. The management server 7 displays a warning message 1109 when detecting that a cursor is placed on the warning display 1108.

When the processing in FIG. 9 is completed, the network system starts the device management service, such as error monitoring, collection and totalization of the usage status with respect to the image forming apparatus specified as the management target via the dialog 1100.

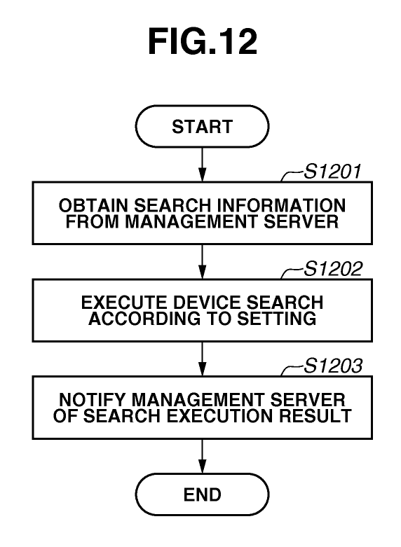

FIG. 12 is a flowchart illustrating an example of the device search processing. FIG. 12 illustrates a flow of the device search processing by the management agent 4a. The processing in FIG. 12 is performed in conjunction with the processing in steps S908 to S910 in FIG. 9.

In step S1201, the control unit 403 requests the device search setting information from the management server 7 via the interface unit 401. The control unit of the management agent obtains the device search setting information managed by the agent management unit 505 from the management server 7. The device search unit 404 of the management agent stores the device search setting information in the storage unit, such as the ROM and the HD of the management agent. The processing in step S1201 is performed in conjunction with the processing in steps S908 and S909 in FIG. 9.

In step S1202, the device search unit 404 executes the device search via the interface unit 401 based on the device search setting information obtained in step S1201. The control unit 403 manages a timing when the device search unit 404 executes the device search processing so as to regularly execute the processing and to execute the processing as response processing with respect to an execution instruction via the user interface of the management agent 4a.

In step S1203, the device management unit 405 transmits an execution result of the search processing in step S1202 to the management server 7 via the interface unit 401. The processing in step S1203 is performed in conjunction with the processing in step S910 in FIG. 9. The execution result of the search processing in step S1202 is an example of a search result of the image forming apparatus by the management agent 4a.

FIGS. 13A and 13B are flowcharts illustrating an example of processing in the entire network system. FIG. 13A is a flowchart illustrating information obtainment processing from the image forming apparatus by the management agent 4a. According to the present exemplary embodiment, the management agent 4a obtains information from the image forming apparatus by the Protocol A in FIGS. 1A and 1B.

In step S1301, the control unit 403 requests device information from the management server 7 via the interface unit 401 and obtains the device information including the items 5101 to 5106 in the table in FIG. 7 from the management server 7. The device management unit 405 stores and manages the device information in the storage unit, such as the ROM and the HD of the management agent 4a.

In step S1302, the device information obtainment unit 406 connects to the image forming apparatus as the management target based on the device information obtained in step S1301 and obtains the device information corresponding to the monitoring information 5108 and the usage status information 5109 from the image forming apparatus. The device management unit 405 stores and manages the device information in the storage unit, such as the ROM and the HD of the management agent 4a. The communication between the management agent 4a and the image forming apparatus as the management target of the management agent 4a performed in step S1302 is an example of communication for monitoring.

In step S1303, the analysis unit 407 determines whether there is the image forming apparatus from which information obtainment is failed as a result of the processing in step S1302. If it is determined that there is the image forming apparatus from which information obtainment is failed (YES in step S1304), the analysis unit 407 advances the processing to step S1304, whereas if it is determined that there is no image forming apparatus from which information obtainment is failed (NO in step S1304), the analysis unit 407 terminates the processing in FIG. 13A.

In step S1304, the analysis unit 407 performs a port scan on the image forming apparatus which is determined that the information obtainment therefrom is failed in step S1303 and checks whether a port necessary for the information obtainment is blocked. Then, the control unit 403 transmits information indicating a result of the port scan by the analysis unit 407 to the management server 7. The information indicating a result of the port scan is an example of communication information of the image forming apparatus which failed in the communication for monitoring with the management agent 4a.

FIG. 13B is a flowchart illustrating processing by the management server 7 after receiving the information transmitted from the management agent 4a in step S1304.

In step S1305, the control unit 503 receives from the management agent 4a via the interface unit 501 information about an information obtainment result of the management target device of the management agent 4a which is the information transmitted in step S1304. The device information management unit 506 stores and manages the information in the storage unit, such as the ROM and the HD of the management server 7. The processing in step S1305 is performed in conjunction with the processing in step S1304.

In step S1306, the control unit 503 receives an information obtainment result display request on the user interface of the management server 7 based on an operation performed on the user interface of the management server 7 by the user (the service provider).

In step S1307, the analysis unit 507 determines whether a port is blocked by the router between the management agent 4a and the image forming apparatus as the management target of the management agent 4a based on the information received in step S1305. If it is determined that the port is blocked by the router between the management agent 4a and the image forming apparatus as the management target of the management agent 4a (YES in step S1307), the analysis unit 507 advances the processing to step S1308. If it is determined that the port is not blocked by the router between the management agent 4a and the image forming apparatus as the management target of the management agent 4a (NO in step S1307), the analysis unit 507 advances the processing to step S1311.

In step S1308, the control unit 503 displays the dialog 1001 to which the information about the information obtainment result received in step S1305 is reflected on the user interface of the management server 7.

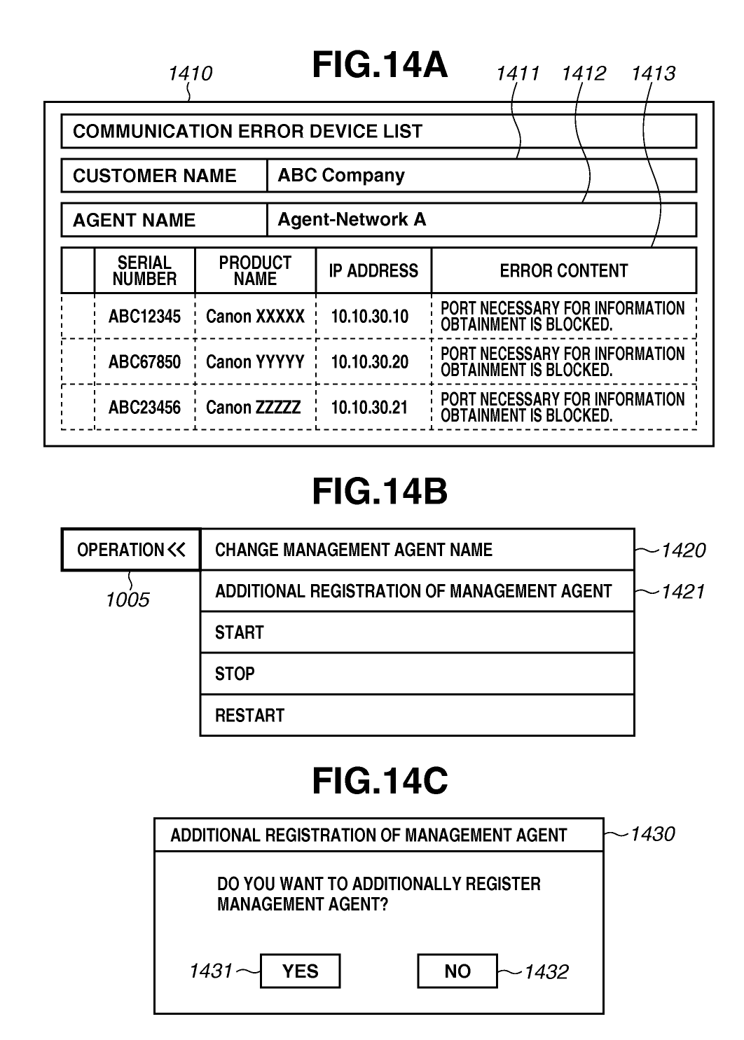

FIGS. 14A, 14B, and 14C illustrate examples of screens displaying a management agent additional registration procedure. The example in FIG. 10A indicates that a communication error occurs in a management agent having a management agent name of an Agent-Network A. The status 1004 is linked to a dialog 1410 illustrated in FIG. 14A.

The dialog 1410 includes a customer name 1411, an agent name 1412, a list box 1413 displaying an image forming apparatus that the management agent corresponding to the agent name 1412 failed in the information obtainment therefrom, and the like.

When pressing down of the “operation” button 1005 in FIG. 10A, the management server 7 displays a sub menu 1420 illustrated in FIG. 14B on the user interface.

In step S1309, the control unit 503 determines whether a selection of an “additional registration of management agent” menu 1421 in the sub menu 1420 is detected via the user interface of the management server 7. If it is determined that the selection of the “additional registration of management agent” menu 1421 in the sub menu 1420 is detected (YES in step S1309), the control unit 503 advances the processing to step S1310. If it is determined that the selection of the “additional registration of management agent” menu 1421 in the sub menu 1420 is not detected (NO in step S1309), the control unit 503 advances the processing to step S1311.

In step S1310, the control unit 503 displays a confirmation dialog 1430 illustrated in FIG. 14C on the user interface of the management server 7. When pressing down of a “YES” button 1431 is detected, the control unit 503 performs additional registration processing. The processing in step S1310 is described in detail below with reference to FIG. 15. When pressing down of a “NO” button 1432 is detected, the control unit 503 discards the processing via the confirmation dialog 1430.

In step S1311, the control unit 503 performs processing for handling a cause of failure in the communication for monitoring other than blocking by the router 6.

In step S1312, the control unit 503 performs the processing similar to that in step S905.

FIG. 15 is a flowchart illustrating an example of the management agent additional registration processing. FIG. 15 illustrates details of the management agent additional registration processing in step S1310.

In step S1501, the control unit 503 determine a management agent additional registration mode via a screen displayed on the user interface of the management server 7. If the management agent additional registration mode is determined as a manual mode (MANUAL in step S1501), the control unit 503 advances the processing to step S1502, whereas if the management agent additional registration mode is determined as an automatic mode (AUTOMATIC in step S1501), the control unit 503 advances the processing to step S1504.

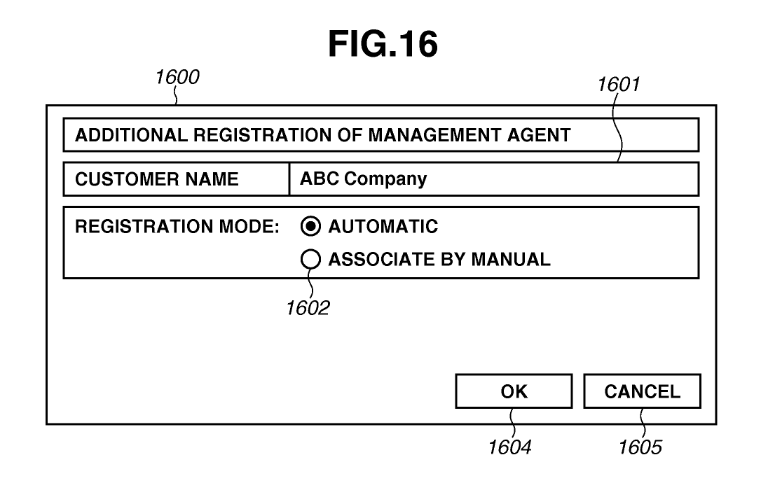

FIG. 16 illustrates an example of a management agent additional registration processing mode setting screen. FIG. 16 is an example of a dialog used in determination processing of the management agent additional registration mode. A dialog 1600 in FIG. 16 includes a customer name 1601, a control group 1602, an “OK” button 1604, a “cancel” button 1605, and the like. The control unit 503 selects an automatic mode or a manual mode of the management agent additional registration mode based on an operation performed on the control group 1602. When pressing down of the “OK” button 1604 is detected, the control unit 503 determines a mode selected in the control group 1602 as the management agent additional registration mode. When pressing down of the “cancel” button 1605 is detected, the control unit 503 discards the processing.

In step S1502, the control unit 503 displays the dialog 1010 illustrated in FIG. 10B on the user interface of the management server 7 based on an operation performed on the user interface of the management server 7 by the user (the service provider). Then, the control unit 503 performs a setting of the management agent to be additionally registered via the dialog 1010.

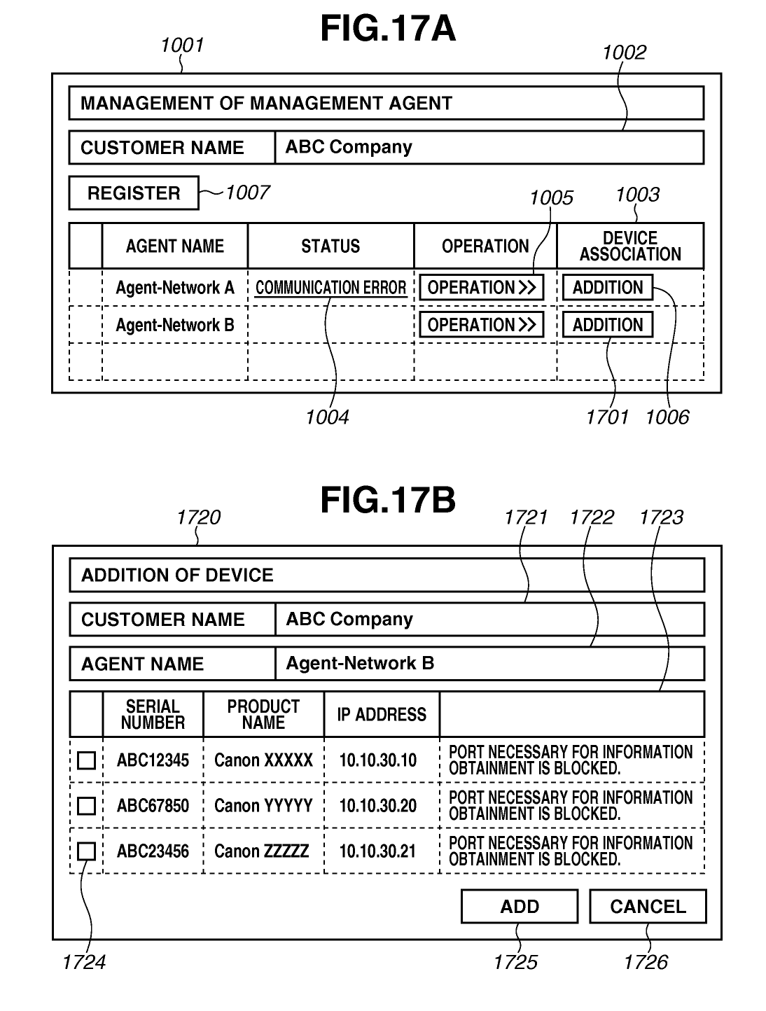

FIGS. 17A and 17B illustrate examples of screens displaying a device association procedure. The processing in step S1502 is similar to the registration processing of the management agent in step S903 when the network system is introduced. The management agent additional registration processing of which is completed can be referred to via the list box 1003 in the dialog 1001 as illustrated in FIG. 17A.

In step S1503, the control unit 503 determines the image forming apparatus to be associated with the management agent additionally registered in step S1502 via the user interface of the management server 7. More specifically, the control unit 503 performs following processing when detecting pressing down of an “addition” button 1701 in the dialog 1001 in FIG. 17A corresponding to an Agent-Network B which is the additionally registered management agent. The control unit 503 displays a dialog 1720 illustrated in FIG. 17B on the user interface of the management server 7. Then, the control unit 503 associates the image forming apparatus as the management target with a management agent 1722 assigned to the customer of a customer name 1721 via the dialog 1720. The control unit 503 detects a selection of a selection button 1724 in a list box 1723 displaying the image forming apparatuses which can be associated with the management agent 1722 via a user operation performed on the dialog 1720. The control unit 503 selects the image forming apparatus to be associated with. When pressing down of an “add” button 1725 is detected, the control unit 503 determines the image forming apparatus selected by the selection button 1724 as the management target of the management agent 1722. When pressing down of a “cancel” button 1726 is detected, the control unit 503 discards the processing and returns to the dialog 1001.

In step S1504, the agent management unit 505 executes the management agent additional registration processing without a user operation. When the processing in step S1504 is executed, the SNMP community name is the one in the setting of the management agent (the subject of the processing in FIG. 13A) referred to at the time of additional registration. According to the present exemplary embodiment, regarding the SNMP community name, information of the management agent “Agent-Network A” is taken over. In addition, regarding the management agent name, a code “_1” is added to an end of the management agent name referred to.

In step S1505, the analysis unit 507 automatically associates the image forming apparatus failed in connection in step S1302 with the management agent automatically registered in step S1504.

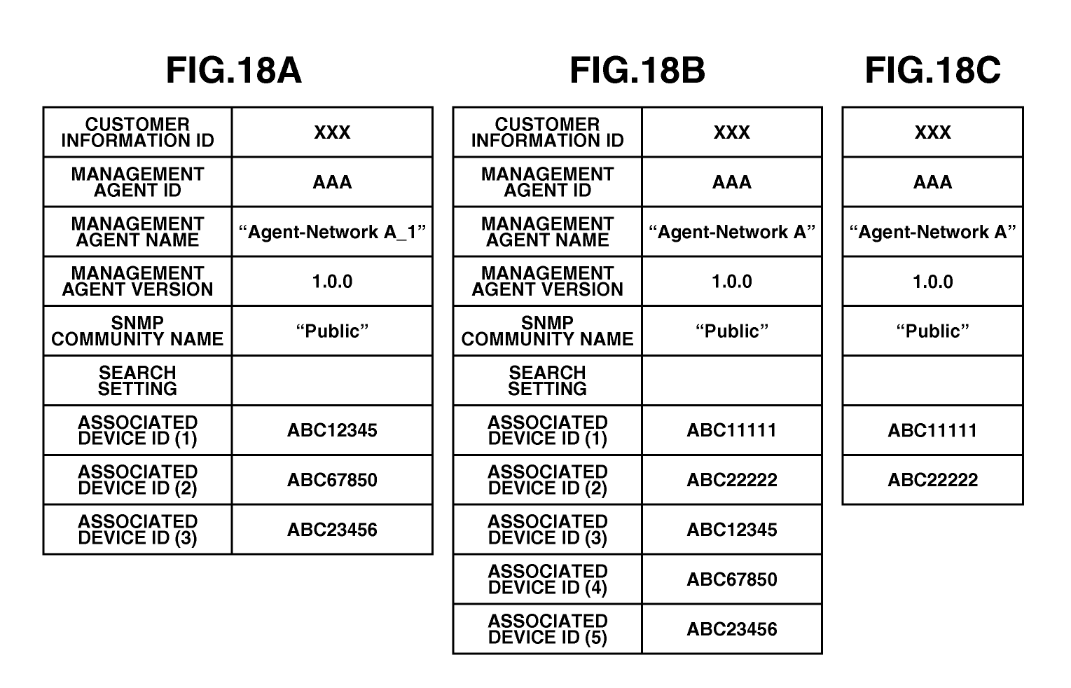

FIGS. 18A, 18B, and 18C are examples of tables indicating a status change in the agent management unit 505. FIGS. 18A, 18B, and 18C indicates the state change of the agent management unit 505 in the management agent additional registration processing. The example in FIG. 18A indicates a state in which the image forming apparatuses (ABC12345, ABC67850, and ABC23456) from which information obtainment is failed in step S1302 are associated with the management agent “Agent-Network A_1” generated in step S1504. Data pieces in the tables in FIGS. 18A, 18B, and 18C are stored in the storage unit, such as the ROM and the HD of the management server 7.

In step S1506, the analysis unit 507 deletes the information of the image forming apparatus associated with the additionally registered management agent from the device management unit 405 of the existing management agent 4a.

The examples in FIGS. 18B and 18C indicate states in which the image forming apparatuses associated with the management agent “Agent-Network A_1” are deleted from the image forming apparatuses associated with the management agent “Agent-Network A”. In FIG. 18C, the data pieces ABC12345, ABC67850, and ABC23456 are deleted from the associated device ID in the management agent “Agent-Network A”.

Thus, details of the management agent automatic additional registration in step S1310 has been described above with reference to the flowchart in FIG. 15.

Then, the control unit 503 transmits a mail including information of the management agent additionally registered in step S1312 to an address indicated by the mail address information of the customer stored in the customer information management unit 504. The mail includes information about a download destination of an installer program of the management agent program for the management agent additionally registered in the customer network environment in step S1310. After completing the processing in step S1312, the management server 7 performs the processing subsequent to step S906 in FIG. 9, and thus the introduction of the additionally registered management agent is completed.

In addition, the mail may include IP address information and subnet information of the IP address of the image forming apparatus associated with the management agent additionally registered in step S1310. Since customer network segment information to which the additionally registered management agent is installed is presented, the customer can efficiently perform the introduction processing with respect to the network system.

The processing according to the present exemplary embodiment enables, in a case where communication between a management agent and an image forming apparatus as a management target of the management agent is blocked by the router 6, the network system to introduce a new management agent which can manage the image forming apparatus. Thus, a user can efficiently perform introduction of the management agent to the network environment as the introduction target.

In the management agent automatic additional registration processing described in steps S1504 to S1505 according to the first exemplary embodiment, the management server 7 additionally registers a single management agent and associates the management agent with all of the image forming apparatuses that the management agent 4a failed in the connection thereto. The processing according to the first exemplary embodiment has an advantage of minimizing the management agent to be additionally registered. However, the processing according to the first exemplary embodiment has an issue that if a network segment of the image forming apparatus to be associated with the management agent and a network segment of the management agent are different, the information obtainment will fail again, and it is necessary to perform again the management agent additional registration processing. Therefore, according to a second exemplary embodiment, the network system may include a configuration that classifies a network segment to which an image forming apparatus belongs based on an IP address of the image forming apparatus from which information obtainment is failed and automatically registers a plurality of management agents.

The system configuration of the network system and the hardware configuration and the software configuration of each system configuration element of the network system according to the present exemplary embodiment are similar to those in the first exemplary embodiment.

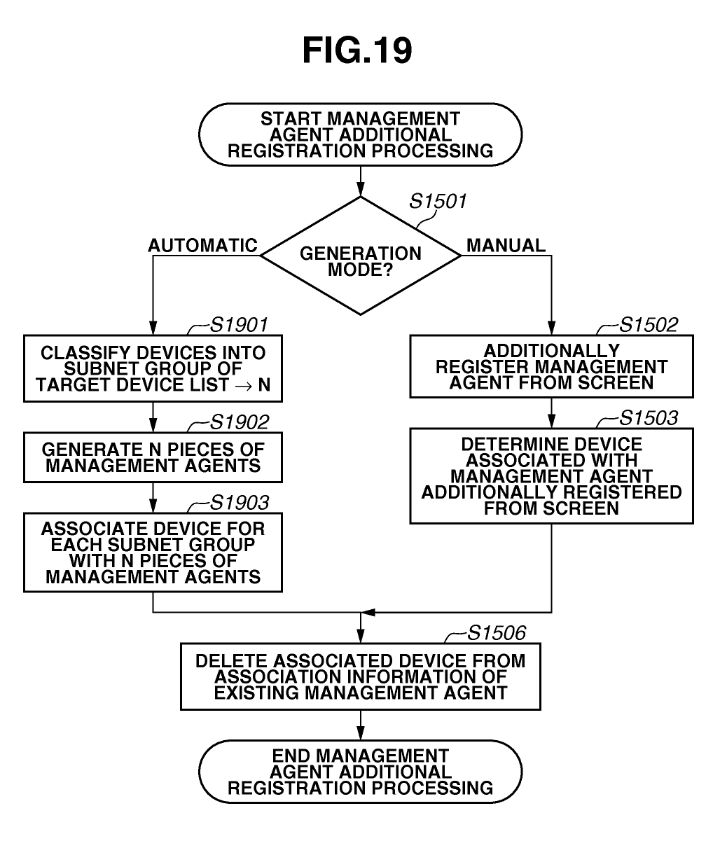

FIG. 19 is a flowchart illustrating an example of the management agent additional registration processing. FIG. 19 illustrates an example of the management agent additional registration processing according to the present exemplary embodiment. Regarding processing in FIG. 19, parts different from the processing in FIG. 15 are described below.

In step S1901, the device information management unit 506 reads the IP address of the image forming apparatus that the management agent 4a failed in the information obtainment therefrom and groups the image forming apparatus for each subnet.

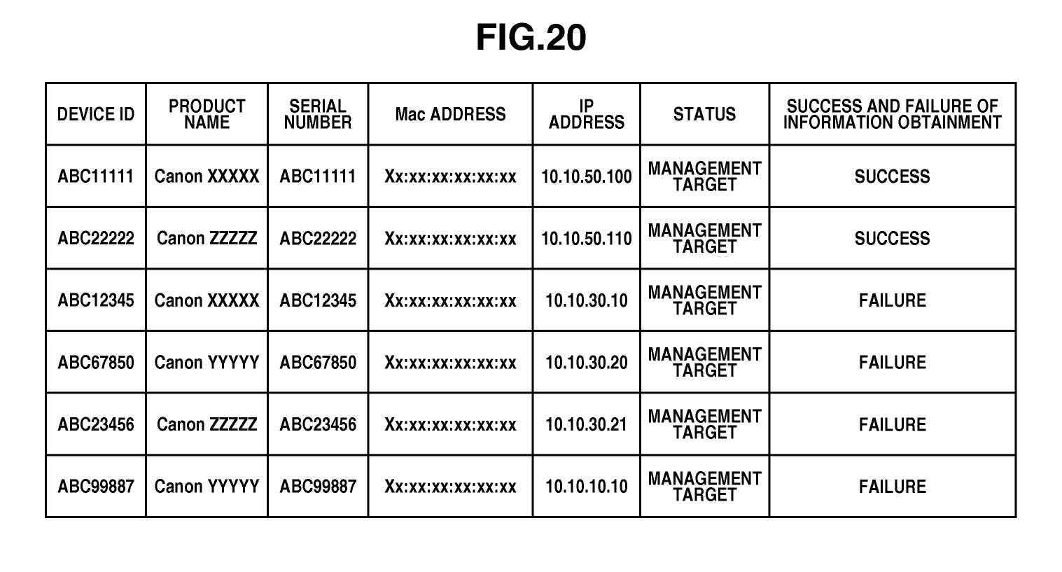

FIG. 20 is an example of a table indicating status examples of the device information management unit 506. FIG. 20 indicates status examples of the device information management unit 506, and according to the present exemplary embodiment, the management agent 4a fails in the information obtainment of four image forming apparatuses ABC12345, ABC67850, ABC23456, and ABC99887. In addition, only an image forming apparatus ABC99887 is connected to a subnet different from that of other three image forming apparatuses. In this case, the number of groups N is two. Data pieces in the table in FIG. 20 are stored in the storage unit, such as the ROM and the HD of the management server 7.

In step S1902, the agent management unit 505 additionally registers N pieces of the management agents. According to the present exemplary embodiment (the example of FIG. 20), the agent management unit 505 additionally registers two pieces of the management agents. Similar to the first exemplary embodiment, the SNMP community name may be taken over the setting of the management agent (the management agent 4a) referred to in the additional registration. In addition, regarding the management agent name, a serial number code, such as “_1”, “_2”, . . . , and “_N” are added to the end of the management agent names referred to.

In step S1903, the analysis unit 507 automatically associates the image forming apparatus for each group classified in step S1901 with the management agent generated in step S1902.

Other processing in FIG. 19 is the same as that in the first exemplary embodiment.

The processing according to the present exemplary embodiment enables the management server 7 to additionally register the appropriate number of management agents if the image forming apparatuses that the management agent 4a failed in the information obtainment therefrom exist across a plurality of network segments.

According to the first and the second exemplary embodiments, the management server 7 executes the management agent additional registration processing based on an operation by a user (a service provider) without inquiring a customer. According to a third exemplary embodiment, the management server 7 inquires necessity to additionally register a management agent from a customer and then performs the processing based on a response to the inquiry.

The system configuration of the network system and the hardware configuration and the software configuration of each system configuration element of the network system according to the present exemplary embodiment are similar to those in the first exemplary embodiment.

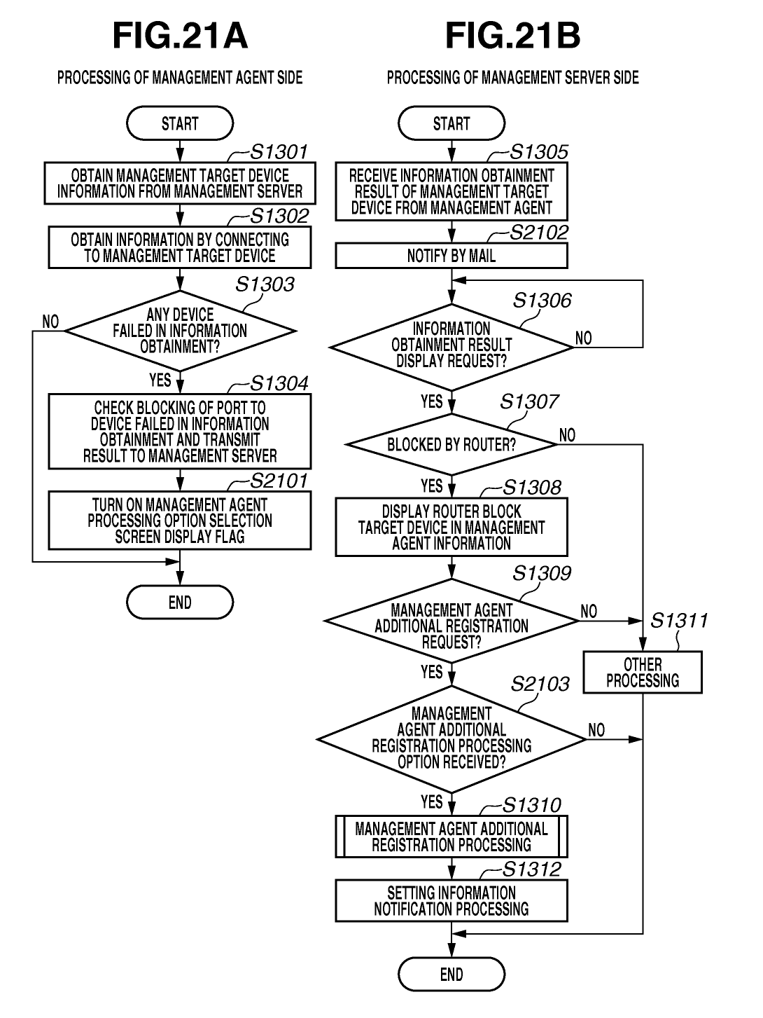

FIGS. 21A and 21B are flowcharts illustrating an example of processing in the entire network system. FIGS. 21A and 21B are flowcharts illustrating an example of processing in the entire network system according to the present exemplary embodiment. Regarding processing in FIGS. 21A and 21B, parts different from the processing in FIGS. 13A and 13B are described below.

In step S2101, the device management unit 405 turns ON a management agent processing option selection screen display flag.

In step S2102, the control unit 503 transmits a mail to notify a mail address of the customer managed by the customer information management unit 504 of a fact that the management agent 4a failed in the information obtainment from the image forming apparatus. The mail includes information about a content of failure in the information obtainment determined in steps S1304 and S1307. In other words, the mail includes information about a content of failure in the information obtainment by the management agent 4a which is caused by blocking of the port by the router or blocking of the port by the image forming apparatus itself.

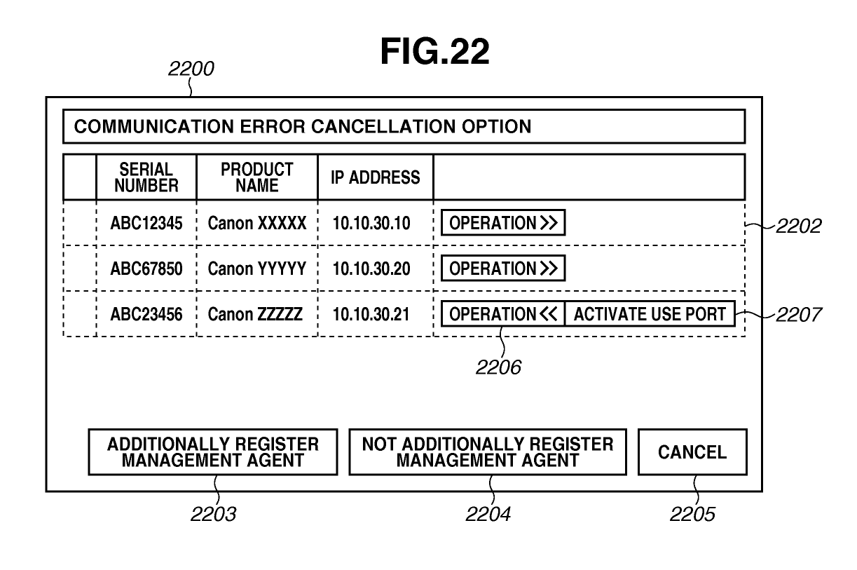

FIG. 22 illustrates an example of a communication error cancellation method selection screen. A dialog 2200 in FIG. 22 is an example of a screen which is displayed by the management agent 4a in response to an operation by a customer on the user interface of the management agent 4a and displayed when the management agent processing option selection screen display flag is ON.

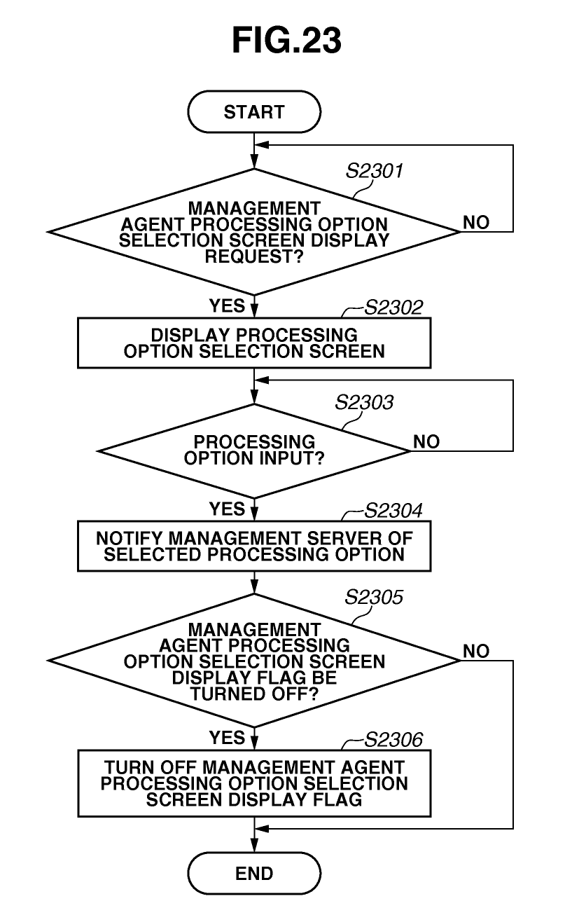

FIG. 23 is a flowchart illustrating an example of communication error cancellation method selection processing. Processing option determination processing by the management agent 4a according to the present exemplary embodiment is described below with reference to the flowchart in FIG. 23.

In step S2301, the control unit 403 determines whether a processing option selection screen display request is received based on an operation performed on the user interface of the management agent 4a by a customer. If it is determined that the processing option selection screen display request is received (YES in step S2301), the control unit 403 advances the processing to step S2302, whereas if it is determined that the processing option selection screen display request is not received (NO in step S2301), the control unit 403 repeats the processing in step S2301.

In step S2302, the control unit 403 displays the dialog 2200 in FIG. 22 on the user interface of the management agent 4a.

The dialog 2200 includes a list box 2202, and an “additionally register management agent” button 2203, a “not additionally register management agent” button 2204, and a “cancel” button 2205 as processing options. The dialog 2200 further includes an “operation” button 2206, a sub menu 2207, and the like which are arranged for each image forming apparatus. In the list box 2202, the image forming apparatus is displayed that the management agent 4a failed in the information obtainment therefrom. The “additionally register management agent” button 2203 is pressed when the customer wants to additionally register the management agent and selected when the failure in the information obtainment from the image forming apparatus is caused by blocking of the port by the router.

The “NOT ADDITIONALLY REGISTER MANAGEMENT AGENT” button 2204 is pressed when the customer wants to change the setting of the customer network environment on his/her own accord to eliminate the failure in the information obtainment from the image forming apparatus. For example, when the failure in the information obtainment from the image forming apparatus is caused by blocking of the port by the router, a case can be considered that the customer does not additionally register the management agent by setting the router not to block communication of the Protocol A.

The “cancel” button 2205 is used to close the screen without selecting the processing.

The “operation” button 2206 is selected when the failure in the information obtainment from the image forming apparatus by the management agent 4a is caused by blocking of the port in the image forming apparatus. When pressing down of the “operation” button 2206 is detected, the management agent 4a displays the sub menu 2207 next to the “operation” button 2206. When a selection of an “activate use port” menu is detected, the management agent 4a opens the port blocked by the image forming apparatus. More specifically, the management agent 4a transmits a port open request MIB to the image forming apparatus using the SNMP.

In step S2303, the control unit 403 determines whether a selection of the processing option via the dialog 2200 is detected. If it is determined that the selection of the processing option is detected (YES in step S2303), the control unit 403 advances the processing to step S2304, whereas if it is determined that the selection of the processing option is not detected (NO in step S2303), the control unit 403 repeats the processing in step S2303.

In step S2304, the control unit 403 notifies the management server 7 of the processing option detected in step S2303.

In step S2305, the control unit 403 determines whether the management agent processing option selection screen display flag can be turned OFF. If it is determined that the management agent processing option selection screen display flag can be turned OFF (YES in step S2305), the control unit 403 advances the processing to step S2306, whereas if it is determined that the management agent processing option selection screen display flag cannot be turned OFF (NO in step S2305), the control unit 403 terminates the processing in FIG. 23.

In step S2306, the device management unit 405 turns OFF the management agent processing option selection screen display flag. More specifically, the device management unit 405 performs following processing if there is any image forming apparatus left which is not subjected to the processing in FIGS. 21A and 21B with respect to the image forming apparatuses that the management agent 4a failed in the information obtainment therefrom. In other words, the device management unit 405 retains the management agent processing option selection screen display flag as ON with respect to the image forming apparatus.

In step S2103, the control unit 503 determines whether a management agent additional registration processing option notified in step S2304 is received. If it is determined that the management agent additional registration processing option is received (YES in step S2103), the control unit 503 advances the processing to step S1310, whereas if it is determined that the management agent additional registration processing option is not received (NO in step S2103), the control unit 503 terminates the processing in FIG. 21. Processing for receiving the additional registration processing option is an example of setting information reception processing of the additional registration processing.

The processing according to the present exemplary embodiment enables the management server 7 to omit unnecessary management agent additional registration processing by performing processing after inquiring the necessity to additionally register the management agent from the customer.

In step S1506 according to the first to the third exemplary embodiments, the processing is described which deletes the information of the image forming apparatus associated with the additionally registered management agent from the association with the management agent 4a at the time of the management agent additional registration processing. According to a fourth exemplary embodiment, when the processing in step S1506 is performed, the management server 7 changes a search setting of the management agent 4a to an appropriate search range.

The system configuration of the network system and the hardware configuration and the software configuration of each system configuration element of the network system according to the present exemplary embodiment are similar to those in the first exemplary embodiment.

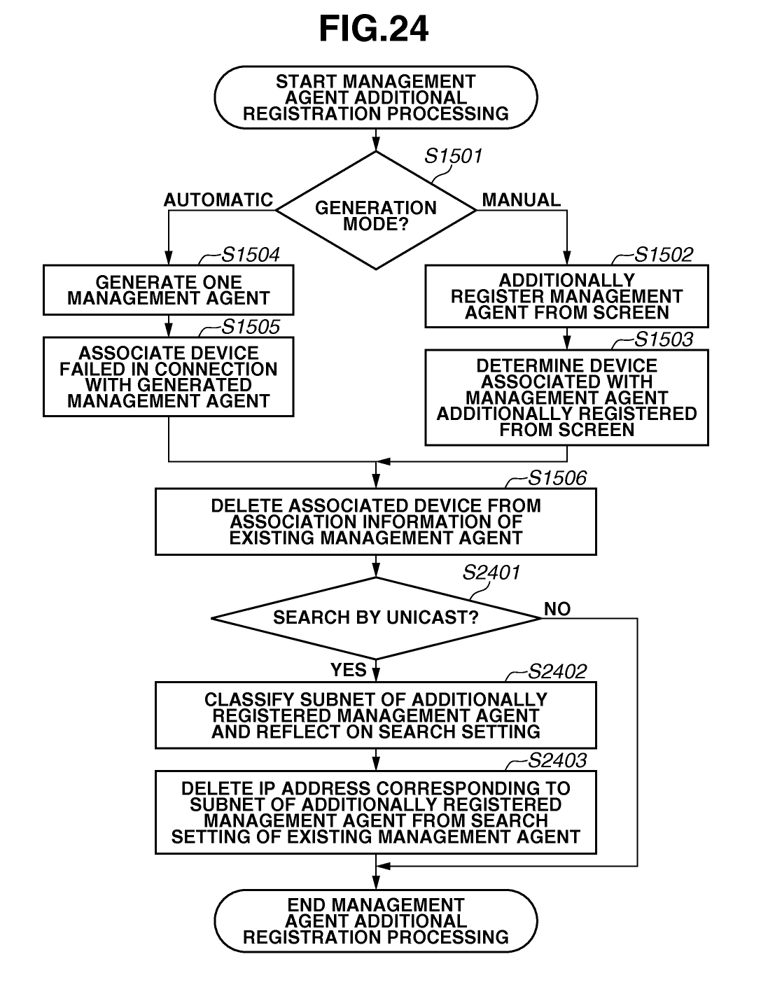

FIG. 24 is a flowchart illustrating an example of search setting automatic updating processing. FIG. 24 illustrates processing for search setting registration according to the management agent additional registration processing. Regarding processing in FIG. 24, parts different from the processing in FIG. 15 are described below.

In step S2401, the agent management unit 505 determines whether the search setting of the management agent 4a is a search by unicast. If it is determined that the search setting of the management agent 4a is a search by unicast (YES in step S2401), the agent management unit 505 advances the processing to step S2402, whereas if it is determined that the search setting of the management agent 4a is not a search by unicast (NO in step S2401), the agent management unit 505 terminates the processing in FIG. 24.

In step S2402, the agent management unit 505 classifies the subnets including the IP addresses of the image forming apparatuses associated with the management agent additionally registered in steps S1502, S1504, S1902, and the like and reflects the classification to the search setting of the management agent.

In step S2403, the agent management unit 505 deletes an IP address range corresponding to the subnet to which the image forming apparatus associated with the additionally registered management agent belongs from the search setting of the management agent 4a. When the agent management unit 505 completes the processing in step S2403, the processing in FIG. 24 is ended.

The processing according to the present exemplary embodiment enables the management server 7 to change the search setting of the management agent 4a to an appropriate search range and to automatically reduce a network traffic by the search.

The management agent program used for additionally registering the management agent in the processing in FIG. 15 and the like is necessary to be installed to the information processing apparatus in the network segment appropriate for obtaining necessary information from the associated image forming apparatus.

Thus, according to a fifth exemplary embodiment, a new additionally registered management agent obtains the IP address information and the like of the image forming apparatus associated with the management agent when an installer program of the management agent is obtained from the management server 7. The management agent installs the management agent program when a subnet of the IP address information matches with a subnet of the IP address of the management agent. The management agent does not install the management agent program when the subnet of the IP address information does not match with the subnet of the IP address of the management agent.

The system configuration of the network system and the hardware configuration and the software configuration of each system configuration element of the network system according to the present exemplary embodiment are similar to those in the first exemplary embodiment.

In addition, for example, the installer program stores the IP address information and the like of the image forming apparatus associated with the management agent. An installer application realized by executing the installer program may not be started if a subnet of an IP address of an execution place is different from a subnet of the IP address information when execution processing is started.

The installer application may notify a user who instructs execution of a warning indicating that an installation environment is inappropriate when suppressing installation of the management agent program to an unexpected network segment.

The processing according to the present exemplary embodiment enables a service provider to reduce an installation load.

According to the first to the fifth exemplary embodiments, the network system includes two computers, namely the computers 1a and 1b, however, the number of the computers is not limited to two and may be three or more, or may be one or zero. The same manner can be applied to the number of the image forming apparatuses included in the network system. The number of the image forming apparatuses is not limited to four, namely the image forming apparatuses 2a, 3a, 2b, and 3b, and may be five or more, or may be three or less. The same manner can be applied to the number of the network segments included in the customer network 10. The number of the network segments is not limited to two, namely the network segments 5a and 5b, and may be three or more, or may be one.

According to the first to the fifth exemplary embodiments, the management server 7 is a single apparatus including the hardware configuration illustrated in FIG. 2. However, the management server 7 may be a management system including one or more apparatuses. As for the system configuration of the management system, there are, for example, a system configuration including a server apparatus and a storage system, a system configuration including a plurality of server apparatuses, and a system configuration including a plurality of server apparatuses and a storage system.

According to the first to the fifth exemplary embodiments, the management server 7 is disposed outside of the customer network 10, however, the management server 7 may be disposed within the customer network 10.

According to the first to the fifth exemplary embodiments, the computers 1a and 1b, the management agents 4a and 4b, and the management server 7 include the hardware configuration similar to that in FIG. 2, however, they may include different hardware configurations. For example, the computers 1a and 1b, the management agents 4a and 4b, and the management server 7 may include a configuration which uses an external storage device without including the HD 111 or uses only the ROM 303 as a storage device. Further, the computers 1a and 1b, the management agents 4a and 4b, and the management server 7 may include a plurality of hard disks instead of a single hard disk as the HD 311.

According to the first to the fifth exemplary embodiments, the image forming apparatus 2a has a scanner function, however, the image forming apparatus 2a may have only a printer function without having the scanner function.

According to the first to the fifth exemplary embodiments, the device ID is the serial number 5103, however, the device ID may be any information as long as which can uniquely specify the image forming apparatus, such as the Mac address 5104.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-207310, filed Oct. 8, 2014, which is hereby incorporated by reference wherein in its entirety.

What is claimed is:

1. A management system with a management agent program installed and communicable with a first information processing apparatus registered as a management agent via a network, the management system comprising:
a first reception unit configured to receive, from the first information processing apparatus, communication information of a network device which failed in communication for monitoring with the first information processing apparatus among network devices as management targets of the first information processing apparatus;
a control unit configured to perform control to register a second information processing apparatus as a management agent to perform the communication for monitoring with the network device corresponding to the received communication information;
a transmission unit configured to transmit to the second information processing apparatus an installer which includes a setting of prohibiting installation to a device not existing in a network segment to which the network device corresponding to the received communication information belongs; and
a change unit configured to change a search range so as to delete the network segment to which the network device corresponding to the received communication information belongs from the search range set with respect to the first information processing apparatus,
wherein, in a case where the transmitted installer is executed in the second information processing apparatus existing in the network segment to which the network device corresponding to the received communication information belongs, a management agent program for managing the network device corresponding to the received communication information is installed in the second information processing apparatus.

2. The management system according to claim 1 further comprising a second reception unit configured to receive a search result as a result of a search of a network device from the first information processing apparatus,
wherein the first reception unit receives communication information of a network device which failed in the communication for monitoring with the first information processing apparatus among the network devices as the management targets of the first information processing apparatus in network devices corresponding to the search result received by the second reception unit.

3. The management system according to claim 1, wherein the communication for monitoring is communication using a predetermined protocol.

4. The management system according to claim 1, wherein the control unit further performs control to transmit to a set address a mail including address information about a requesting destination of an installer of the management agent program.

5. The management system according to claim 1 further comprising a setting information reception unit configured to receive setting information of processing to the network device obtained from the first information processing apparatus via a setting screen,
wherein the control unit performs control to register the second information processing apparatus as a management agent based on the setting information received by the setting information reception unit.

6. The management system according to claim 1, wherein the network device is an image forming apparatus.

7. A method performed in a management system with a management agent program installed and communicable with a first information processing apparatus registered as a management agent via a network, the method comprising:
receiving, from the first information processing apparatus, communication information of a network device which failed in communication for monitoring with the first information processing apparatus among network devices as management targets of the first information processing apparatus;
performing control to register a second information processing apparatus as a management agent to perform the communication for monitoring with the network device corresponding to the received communication information;
transmitting to the second information processing apparatus an installer which includes a setting of prohibiting installation to a device not existing in a network segment to which the network device corresponding to the received communication information belongs; and
changing a search range so as to delete the network segment to which the network device corresponding to the received communication information belongs from the search range set with respect to the first information processing apparatus,
wherein, in a case where the transmitted installer is executed in the second information processing apparatus existing in the network segment to which the network device corresponding to the received communication information belongs, a management agent program for managing the network device corresponding to the received communication information is installed in the second information processing apparatus.
